(19) United States
(12) Patent Application Publication
(10) Pub. No.: US 2010/0026103 A1
(43) Pub. Date: Feb. 4, 2010

(54) DRIVING OR POWER GENERATING MULTIPLE PHASE ELECTRIC MACHINE

(75) Inventor: Dominique Sabadie, Toulouse (FR)

Correspondence Address: CANTOR COLBURN, LLP, 20 Church Street, 22nd Floor, Hartford, CT, 06103, US

(73) Assignee: DELTY, TOULOUSE (FR)

(21) Appl. No.: 12/522,228

(22) PCT Filed: Dec. 20, 2007
(86) PCT No.: PCT/FR07/02132

§ 371 Date: Aug. 18, 2009

(30) Foreign Application Priority Data
Jan. 12, 2007 (FR) 07 00235

(51) Int. Cl. H02K 41/03; H02K 37/02; H02K 1/06

(52) U.S. Cl. 310/12.14; 310/46; 310/216.001

(57) ABSTRACT

The electric machine of the invention operates in a synchronous manner based on the principle of reluctance variation. It comprises the following combination: a fixed portion (1) with notches (11) for receiving armature coils (12) connected in series by phase, wherein the successive windings as wound in opposite directions; a mobile portion (4) with teeth (6) facing the notches (11), wherein to a tooth of the mobile portion corresponds a number M×(2P) of notches in the fixed portion, M being an integer and P the number of phases; an excitation portion (15) with a coil or a permanent magnet for generating a continuous magnetic flow between the fixed (1) and mobile (4) portions. The invention can be used in the production of rotary or linear synchronous electric motors and in the production of alternators.

The present invention relates to a polyphase driving or generating electric machine that is able to be made like a rotary machine or like a linear machine, and operating in a synchronous manner on the principle of reluctance variation. It is, in particular, a “power” machine for various industrial uses.

In the field of electric machines, it should be noted that a driving machines usually designated as an electric motor, consumes electric energy and produces mechanical energy. Conversely, a generating machine, usually designated as a generator or alternator, consumes mechanical energy and produces electric energy.

An electric source is called polyphase when it comprises two or more phases. Three-phase electric current, that is to say comprising three phases, is commonly used.

A synchronous electronic machine rotates at a fixed rotation speed which is a multiple of the frequency of its electric supply current.

Reluctance is the quotient of the magneto-driving force of a magnetic circuit by the magnetic flux which passes through it. The reluctance variation therefore creates a variation of magnetic flux and of magneto-driving force. The variation of magnetic flux itself creates, through a coil, a variation of current. The magneto-driving force creates a linear movement or a rotation on a rotor.

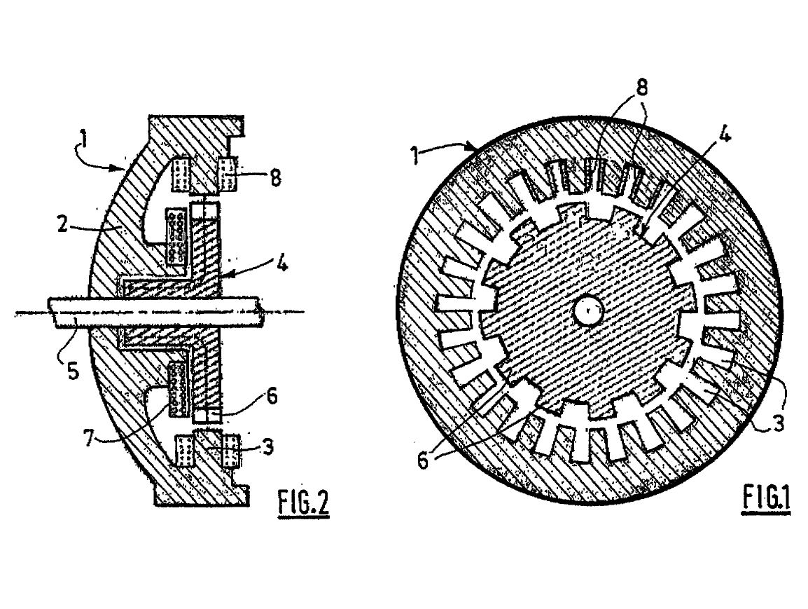

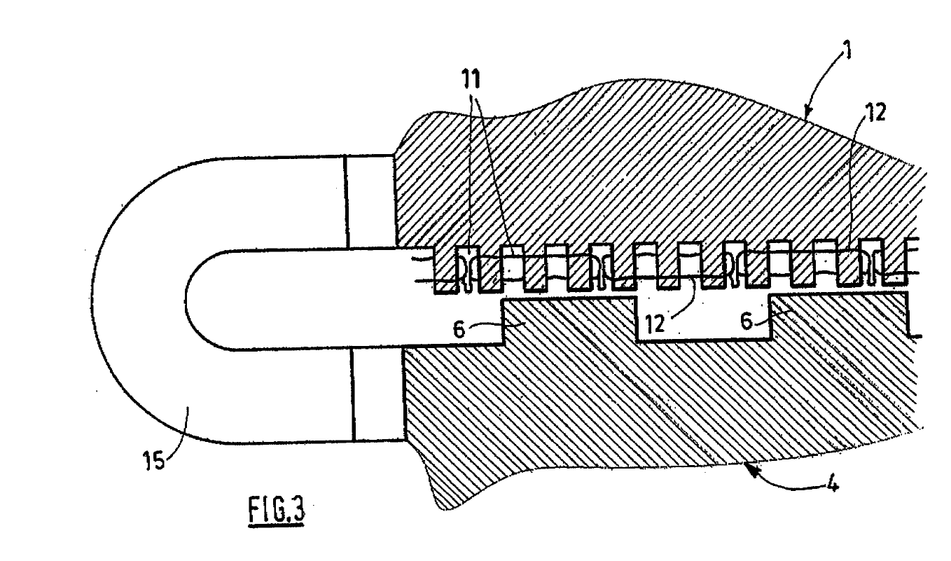

With these electrotechnical principles and definitions being remembered, reference is first made, as the prior art, to a particular electric rotating machine known as a BETHENOD-LATOUR alternator, made with a single phase for applications in the radio field. FIGS. 1 and 2 are views, respectively in section pass through the axis and in cross section, of such an alternator.

In this machine, the inductor and the armature are both immobile. The stator 1 consists of a solid disk or endpiece 2, provided at its periphery, forming an armature core, with an even number 2N of notches 3. The rotor 4 is an iron wheel, with no winding, which is immobilized on a central shaft 5 and which comprises at its periphery a number equal to N of teeth 6.

The magnetic flux is produced by a fixed inductive coil 7, placed at the center of the stator 1, facing the notched wheel of the rotor 4. The magnetic circuit consists of this movable wheel, the armature core and the endpiece 2.

Placed in the 2N notches 3 of the armature core 2 are armature coils 8, 2N in number, electrically connected together in series, their successive windings being coiled in the reverse direction so that the electromotive forces are in phase and are added together.

In operation, the shaft 5 being rotated by an external source of movement, the teeth 6 of the wheel of the rotor 4 pass in front of the fixed notches 3 of the armature core, hence in front of the armature coils 8. For each notch 3, when a tooth 6 of the rotor 4 passes, the magnetic flux varies from zero to a maximum value and then returns to zero, thereby giving birth, each time a tooth 6 passes, to an alternating voltage in the coil 8 of the notch 3 in question. The frequency of this alternating voltage, hence of the electric current produced by the alternator, is a function of the rotation speed of the rotor 4, in other words of the rotation speed of the shaft 5.

The arrangement of the stator of this alternator, called a rotating iron alternator, makes it possible to increase the number of peripheral notches and therefore to produce, without increasing the rotation speed of the rotating portion, an electric current of higher frequency. The object of the present invention is to provide an electric machine, being inspired from that previously mentioned, but having increased possibilities, in particular an electric machine that is able to be either a driving machine or a generating machine, and that may also have a polyphase operation, while maintaining a simple, reliable and economical structure.

Accordingly, the main subject of the invention is a polyphase driving or generating electric machine that is able to be made like a rotary machine or like a linear machine, and operating in a synchronous manner on the principle of reluctance variation, which comprises in combination: a fixed portion with notches housing armature coils connected together electrically in series, by phase, their successive windings being coiled in inverse directions; a movable portion provided with teeth situated facing the notches of the fixed portion with one tooth of the movable portion corresponding to a number M×(2P) of notches of the fixed portion, “M” being an integer equal to or greater than one and “P” designating the number of phases of the machine; and an excitation portion, facing the fixed portion and the movable portion, with an electromagnetic coil supplied with direct current or with a permanent magnet, and with a magnetic circuit causing a continuous excitation magnetic flux to travel between the fixed portion and the movable portion.

In particular, the polyphase electric machine of the invention can be made as an electric rotary machine with “P” phases, the latter comprising in combination an annular stator comprising at its periphery radial notches M×(2N×P) in number, in which are placed as many armature coils, offset from one phase to another; a rotor mounted so as to rotate along the central axis of the machine and provided at its periphery with teeth that are “N” in number, protruding radially and situated facing the notches of the stator; and a fixed excitation portion placed in the center of the stator about the axis of the machine.

In such an electric machine, the “excitation” and “armature” portions are fixed, and there is therefore no winding or magnet on the movable portion, in particular on the rotor in the case of a rotary machine. Only the portions subjected to the magnetic field at a more or less high frequency are advantageously made of thin foliated metal sheets in order to limit the efficiency losses by Eddy currents; in practice, in the case of a rotary machine, this means that only the ring of the stator comprising the M×(2N×P) radial notches is foliated. The other portions, in particular the portion of the stator supporting the exciter and all of the movable portion, in other words the rotor with its N teeth, are preferably solid, the teeth being able to be machined on the periphery of the rotor. These particular features make the electric machine that is the subject of the invention a remarkably simple and economical machine.

The notably fixed exciter portion may comprise an electromagnetic coil supplied with direct electric current, or, as a variant, a permanent magnet. An electromagnetic coil provides more flexibility and variability for controlling the machine, and it makes it possible to obtain stronger magnetizations than those of permanent magnets; the driving force or the torque resulting therefrom are just as much enhanced. However, excitation via a permanent magnet is a simple and economic solution, both for the structure of the electric machine itself and for the production of the electronics for controlling the machine. In all cases, the exciter portion is fixed and clearly distinct from the armature, and it creates a magnetic excitation flux that is direct (and not alternating).

The polyphase electric machine that is the subject of the present invention can be made as a synchronous electric motor of the rotary or linear type, or as an alternator, notably as a three-phase electric motor or as a three-phase alternator, preferably with an excitation portion that can be controlled so as to vary the direct excitation magnetic flux.

This machine differs, in particular, from the devices known according to U.S. Pat. No. 4,631,510 and U.S. Pat. No. 3,041,486 which are not electric “power” machines but are of the “resolver” type, that is to say which constitute electric angular-position sensors, in which very low currents flow, the implied powers being minimal. In addition, in these two documents, the excitation winding is housed in the stator and embedded in the armature coils, and this excitation winding is supplied with alternating current and not with direct current, so that it generates an excitation flux which is also alternating and not direct.

In the “driving” operating mode of the electric machine according to the invention, a polyphase, for example three-phase, electric current at variable frequency and voltage, is sent into the coils of the stator. The machine then operates like a synchronous electric motor, the movable portion (rotor) moving relative to the fixed portion (stator) at a speed that is proportional to the frequency of the supply current and that is inversely proportional to the number of teeth or notches. In a simple and economic manner, this gives a synchronous electric motor with no coil and no magnet on its movable portion, in particular on its rotor.

In “generating” mode, the rotor is rotated by an external source of movement and it creates, in each of the armature coils, an alternating current. More particularly, the movable portion (rotor) magnetized by the excitation portion “brushes” the armature coils, and the variation of flux thus created generates an alternating current the frequency of which is proportional to the speed of relative movement of the movable and fixed portions. The electric voltage which then appears is a function of the relative speed and of the excitation flux. Since the electromotive forces of the armature coils are added together, for each phase, the machine operates in the manner of an alternator supplying notably a three-phase current, the frequency of the current generated being proportional to the rotation speed. It is therefore possible to obtain high frequencies at low rotation speeds, simply by multiplying the teeth of the rotor and, in a corresponding manner, the notches of the stator. It is therefore possible to produce simplified and economic alternators, with a minimum number of components, for example motor vehicle alternators which would be reliable and powerful.

In all cases, in other words whether the electric machine is a driving machine or a generating machine, the magnetic flux passing through the machine can be controlled and the maximum rotation speed of the rotor is not limited. In additions the teeth of the rotor have an advantageous effect of fan blades and provide an easy cooling of the machine. These advantages make it possible to produce motors or generators operating over a wide speed and torque range, therefore to delete in certain applications the usual speed-increasing or speed-reducing gears, resulting in a simplification of the kinematics and an increase in reliability. For example, in the application of wind turbines, the invention makes it possible to dispense with the speed-increasing gears and to obtain directly the desired frequency of electric current.

The invention will be better understood with the aid of the following description, with reference to the appended schematic drawing representing, as an example, a form of execution of this polyphase driving or generating electric machine:

FIG. 1 (already mentioned) is a view in section passing through the axis of an electric rotary machine of the prior art;

FIG. 2 (already mentioned) is a view in cross section of the electric machine of FIG. 1;

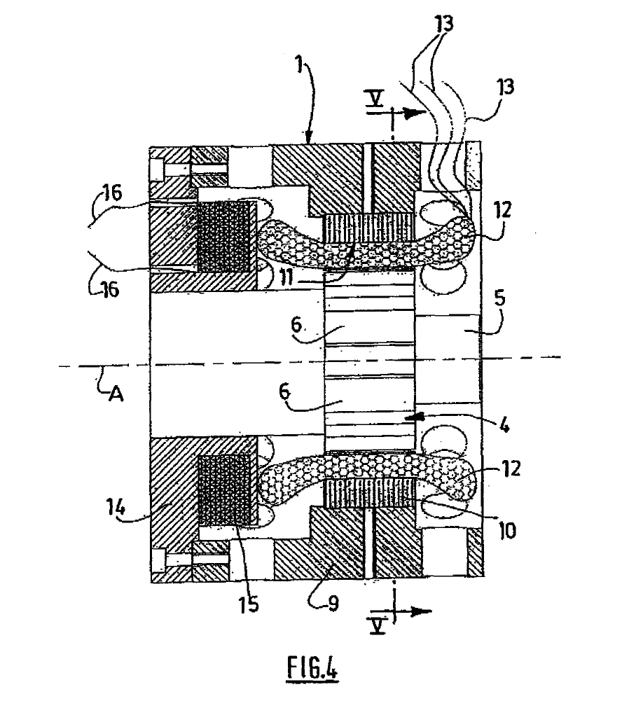

FIG. 3 is a schematic diagram of an electric machine according to the present invention;

FIG. 4 is a view in section passing through the axis of an electric rotary machine according to the present invention;

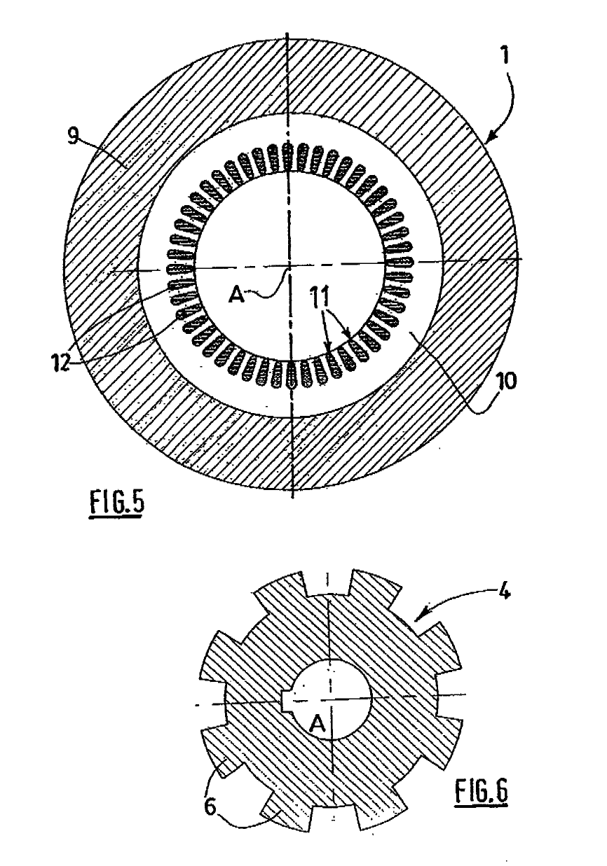

FIG. 5 is a view in cross section of the stator of this electric machine, along the line V-V of FIG. 4;

FIG. 6 is a view in cross section of the rotor of the electric machine of FIGS. 4 and 5;

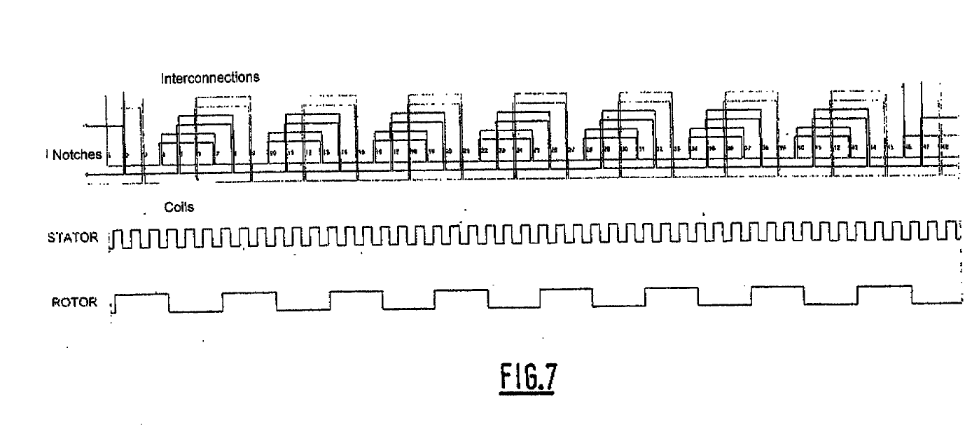

FIG. 7 is a schematic diagram in developed representation of the electric machine according to the invention, in line with the example of FIGS. 4 to 6.

With reference to FIG. 3, the general principle of a polyphase electric machine according to the present invention will first be explained, this machine being able to be driving or generating, rotary or linear. The electric machine comprises, in all cases, a fixed portion 1 and a movable portion 4, that is to say a portion that is capable of describing a rotary or rectilinear movement relative to the fixed portion 1.

The movable portion 4, of solid structure, is provided on its periphery or on its border with teeth 6, separated by notches, the number of teeth 6 or of notches being indicated by N.

The fixed portion 1, which may also be designated as “armature”, has a series of notches 11 situated facing the teeth 6 of the movable portion 4. The total number of notches 11 is equal to (2N×P), or to an integer multiple M of the number (2N×P), N being the number of teeth 6 of the movable portion 4, and P designating the number of phases.

In the (2N×P) or the M×(2N×P) notches 11 of the fixed portion 1 there are as many armature coils 12. For clarity of the drawing, FIG. 3 shows only the coils of one phase, which are connected together in series, their successive windings being coiled in inverse directions, so that all of the electromotive forces are in phase and are added to one another. Each set of coils 12 of a phase is offset relative to the previous one, by one notch 11 or by the multiple M of notches.

The machine also comprises an excitation portion 15, with an electromagnetic coil or with a permanent magnet, which faces at the sate time the fixed portion 1 and the movable portion 4. This therefore creates a closed excitation magnetic circuit which circulates a direct current magnetic flux between the fixed portion 1 and the movable portion 4 of the machine. More particularly, the direct current magnetic flux generated by the excitation portion 15 closes between the fixed portion 1, in the region of the notches 11 and of the coils 12 of the latter, and the top of the teeth 6 of the movable portion 4.

When the movable portion 4 moves relative to the fixed portion 1, any magnetic coil 12 passes in an alternating manner from a maximum magnetic flux, present at the top of the teeth 6 of the movable portion 4, to a minimal magnetic flux, present at the bottom of the notches situated between the teeth 6 of this movable portion 4. When an armature coil 12 is at the maximum magnetic flux, the next armature coil 12 (of the same phase) is at the minimal magnetic flux, as is clearly shown in FIG. 3. Since this next coil is wound in the inverse direction from the previous one, the fluxes seen by the two coils 12 in question are placed in phase; the induced electric currents are therefore added together, from coil to coil.

In “generating” mode, the movable portion 4 being moved by a source of movement outside the machine, the variation of flux in each armature coil 12 creates an electric current which, by being added to the similar effect produced in the other coils 12 and by being multiplied by the number P of phases, creates overall an alternating current electric current that can be collected.

Conversely, in “driving” mode, alternating current is sent to the armature coils 12 of the fixed portion 1. This alternating current varies the magnetic flux of the excitation portion 15, which is still active. The reluctance of the magnetic circuit means that the variation of the magnetic flux is reflected by the appearance of a variation of magnetic force, which acts on the movable portion 4. The latter is therefore moved, and its movement (rotary or linear) may be collected, as a driving source.

FIGS. 4 to 6, in which the elements corresponding to those defined above are indicated by the same reference numbers, illustrate the application of the principle of this polyphase electric machine to the constitution of a three-phase electric rotary machine.

This electric rotary machine, the central axis of which is indicated as “A”, comprises in a general manner a fixed portion designated as the stator 1, and a movable portion rotating about the axis A designated as the rotor 4, which is immobilized on a central shaft 5 (or forms only a single piece with this shaft).

The rotor 4, clearly visible in FIG. 6, has a solid structure and is provided with teeth 6 evenly spaced on its periphery, the number of teeth 6 being designated by N.

The stator 1 comprises, placed about the rotor 4, a solid cylindrical casing 9 which supports, internally, a ring formed by a stack of foliated metal sheets 10 having evenly spaced radial notches 11 situated facing the teeth 6 of the rotor 4 (FIG. 5 being a view in section passing through this portion of the stator 1). The notches 11 number (2N×P) in total, P designating the number of phases, namely a number of notches equal to (6×N) in the example considered here of a three-phase machine.

Placed in the (6×N) notches 11 of the stator 1 are as many armature coils or stator coils 12, that can be seen in FIG. 4. The armature coils 12, distributed in three phases, are, for each phase, connected together electrically in series, their successive windings being coiled in inverse directions. An offset of a notch 11 is provided between the phases. The set of coils 12 is connected to electrical connections 13 of the stator 1, in this instance three-phase connections 13, with alternating current passing through them.

At one end of the machine, the stator 1 again comprises a solid endpiece 14 of circular or annular shape, which supports a fixed excitation coil 15 coaxially surrounding the shaft 5 of the rotor 4, and situated facing the armature coils 12. The excitation coil 15 is supplied with direct current by electrical connections 16, consisting notably of two supply wires. In operation, that is to say when the excitation coil 15 is electrically supplied, the latter generates a direct current magnetic flux, closing between the stator 1 and the periphery of the rotor 4.

This forms a three-phase electric rotary machine, of the synchronous type and with variable reluctance, which can operate as an electric motor or as a three-phase alternator.

In “driving” operation mode, a controlled three-phase electric current, at variable frequency and voltage, is sent via the electrical connections 13 into the coils 12 of the stator 1, while the excitation coil 15 is supplied with direct electrical current via the connections 16. The rotor 4 then rotates at a speed proportional to the control frequency, the movement of the rotor 4 being collected on the shaft 5.

In “alternator” operating mode, the rotor 4 is rotated by its shaft 5 from an external source of movement, while the excitation coil 15 is supplied with direct electrical current. The reluctance variation then produced in front of each coil 12 of the stator 1 creates an alternating current which is collected on the electrical connections 13. More particularly, a three-phase current is generated in this instance, the frequency of which is a function of the speed of rotation of the rotor 4.

This operating mode is specified below, taking as an example a three-phase electric rotary machine the rotor 4 of which comprises eight teeth 6, as shown in FIG. 6 (therefore: N=8), while the stator 1 and more particularly the stack of foliated metal sheets 10 comprises in total 48 notches 11, since, in this case, by choosing M=1 to give a simple example: M×(2N×P)=1×2×8×3=48.

This example also corresponds to the simplified developed representation of FIG. 7.

In the context of this example, in “alternator” mode with a rotation speed of the rotor 4 equal to 3000 revolutions per minute (that is 50 revolutions per second), the frequency of the electric current induced in the stator 1 will be: 50×8=400 Hz.

Conversely, in “driving” mode and by electrically supplying the stator 1 at a frequency of 400 Hz, the rotor 4 will rotate at a speed of 3000 revolutions per minute.

The polyphase electric rotary machine previously described can therefore be used as a synchronous electric motor, supplied in particular by a three-phase current, the rotor 4 rotating at a rotation speed that is a multiple of the supply current frequency. The value of the invention in this instance lies in a simple and economic production of a synchronous electric motor, with a solid unfoliated rotor, with no coil and no magnet on the rotor.

The principle of this electric machine may be extended to the production of an economical linear electric motor. The developed representation of FIG. 1 also gives an idea of a linear electric motor according to the present invention.

In the driving operating mode, the use of an excitation coil 15 creating a variable excitation allows control of the electromotive force, in any operating condition in terms of speed and force or torque of the movable portion 4. This makes it possible notably to increase the range of speeds of the synchronous motor thus formed, compared with current motors. Therefore, an electric motor according to the invention, associated with a control circuit that is simple to produce, can advantageously replace current asynchronous, synchronous or direct current electric motors or gear motors, in all the applications in which they are used today. By virtue of the simplicity of its rotor and of its cooling, the electric machine according to the invention is particularly suited to the production of high-speed electric motors, for example electric motors rotating at speeds higher than 8000 revolutions per minute. However, by virtue of the possibility to simply increase the number of “poles”, that is to say the number of teeth 6 of the movable portion (rotor) 4 and the corresponding number of notches 11 of the fixed portion (stator) 1, the electric machine according to the invention is also particularly suited to the production of electric motors rotating at relatively low speeds, for example speeds below 400 revolutions per minute.

In the case of a polyphase electric machine according to the invention operating as an alternator, the excitation coil 15, properly supplied, creates a variable excitation which allows control of the alternating output voltage, collected on the electric connections 13, for a given speed, hence for a given frequency. In addition, if the alternator is coupled to a network, this excitation makes it possible to act on the power factor of the network. It is therefore possible to produce a simplified and economic alternator with a minimum of components. These features are of value for example for producing reliable and powerful motor vehicle alternators, or tachymetric alternators making it possible to measure the speed and position of a movable element or of a rotor, or else synchronous compensators of reactive energy on the electricity distribution networks. It will also be noted that, in “alternator” mode, for a given rotation speed of the rotor 4, it is sufficient to multiply the number of teeth 6 of this rotor in order to increase the frequency of the alternating current generated. Therefore, the value of the electric machine that is the subject of the invention, used as an alternator, also lies in the possibility of obtaining high frequencies for relatively low rotation speeds, which allows an advantageous use of this machine in fields such as not only electricity generation in motor vehicles but also aviation electricity generation, wind turbines, hydroelectric power stations, energy conversion.

The natural reversibility of the electric machine that is the subject of the invention also allows a “mixed” use, that is to say as a machine that is a driving or generating machine depending on the moment. The value of the invention is in this instance to supply an economical reversible electric machine which makes it possible to envisage, for example, the following uses:
as a starter-alternator for a heat engine, notably of a motor vehicle;
as a means of storage-retrieval of kinetic energy.

By coupling electric machines according to the invention, it is furthermore possible to produce an “electric shaft”, which transmits a rotary or linear movement, just as well as a linear speed-increasing or speed-reducing gear.

As a result of the foregoing, the electric machine that is the subject of the invention finds applications in many, varied fields of activity: industry; transport, particularly in motor vehicles, aviation and space, sea; energy production and conversion; domestic equipment.

The invention is not restricted solely to the embodiment of this polyphase driving or generating electric machine that has been described above as an example; on the contrary, it covers all the variants of embodiment and of application included in the appended claims. Therefore, in particular, there would be no departure from the context of the invention:
by modifying the number N of teeth of the movable portion, in particular of the rotor, and the number of notches of the fixed portion, in particular of the stator, provided that the latter number maintains the relation M×(2N×P);
by modifying the number P of phases of the electric machine;
by replacing the fixed excitation coil with a permanent magnet that is also fixed, which may provide a simplification and a saving, if a variation of excitation is not necessary;
by placing the excitation coil, or if necessary the permanent magnet, at any appropriate point on the excitation magnetic circuit;
by modifying the constructive details of the fixed and movable portions, in particular of the stator and of the rotor, or the proportions (length/diameter) of the electric machine;
by producing this electric machine to all dimensions, depending upon the power demanded by the application;
by insulating the movable portion from the fixed portion of the electric machine by an amagnetic wall, the movable portion thereby being able to be immersed in a hostile environment;
finally, by producing this electric machine, particularly as a driving machine, as a linear and nonrotary machine, in which case the fixed portion with notches incorporates the excitation portion, while the rotor is replaced by a toothed portion that can move in translation (in the latter case, the terms “fixed” and “movable” have only a relative meaning, in order to indicate the possibility of movement of one portion relative to another).

1. A polyphase driving generating electric machine that is able to be made like a rotary machine or a linear machine, and operating in a synchronous manner on the principle of reluctance variation, comprising:
a fixed portion with notch housing armature coils connected together electrically in series, by phase, their successive windings being coiled inverse directions;
a moveable portion provided with teeth situated facing the notches of the fixed portion with one tooth of the moveable portion corresponding to number M×(2P) of notches of the fixed portion, “M” being an integer equal to or greater than one and “P” designating a number of phases of the machine; and
an excitation portion, facing the fixed portion and the movable portion, with an electromagnetic coil supplied with direct current or with a permanent magnet, and with a magnetic circuit causing a continuous excitation magnetic flux to travel between the fixed portion and the moveable portion.

2. The polyphase driving or generating electric machine as claimed in claim 1, wherein it is made like an electric rotary machine with “P” phases, comprising in combination: an annular stator comprising at its periphery radial notches M×(2N×P) in number, in which are placed as many armature coils, offset from one phase to another; a rotor mounted so as to rotate along the central axis of the machine and provided at its periphery with teeth and are “N” in number, protruding radically and situated facing the notches of the stator; and a fixed excitation portion placed in the center of the stator about the axis of the machine.

3. The polyphase driving or generating electric machine as claimed in claim 2, wherein the stator comprises, about the rotor, a solid cylindrical casing which supports internally, a ring formed by a stack of foliated metal sheets having the radial notches situated facing the teeth of the rotor.

4. The polyphase driving or generating electric machine as claimed in claim 2, wherein the stator comprises, at one end of the machine, a solid endpiece of circular or annular shape, which supports a fixed excitation coil surrounding coaxially the shaft of the rotor and situated opposite the armature coils of the stator.

5. The polyphase driving or generating electric machine as claimed in claim 2, wherein the rotor has a solid structure.

6. The polyphase driving or generating electric machine as claimed in claim 1, configured as a synchronous electric motor of the rotary or linear type, or as an alternator.

7. The polyphase driving or generating electric machine as claimed in claim 6, configured as a synchronous electric motor of the rotary or linear type comprising a three-phase electric motor with an excitation portion that can be controlled so as to vary the continuous excitation magnetic flux.

8. The polyphase driving or generating electric machine as claimed in claim 6, configured as an alternator comprising a three-phase alternator with an excitation portion that can be controlled so as to vary the continuous excitation magnetic flux.
